(19) United States
(12) Patent Application Publication
(10) Pub. No.: US 2007/0174501 A1
(43) Pub. Date: Jul. 26, 2007

(54) SYSTEM AND METHOD FOR MANAGING A DATA TRANSFER CHANNEL BETWEEN COMMUNICATION DEVICES

(75) Inventors: BOR-CHUAN LIN, Tu-Cheng (TW); JUN-FENG WANG, Shenzhen (CN); CAI-YANG LUO, Shenzhen (CN); GAO-PENG HU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/563,152

(22) Filed: Nov. 25, 2006

(30) Foreign Application Priority Data
Jan. 6, 2006 (CN) 200610032816.8

(51) Int. Cl. G06F 3/00

(52) U.S. Cl. 710/15

(57) ABSTRACT

A method for managing a data transfer channel between communication devices includes: monitoring the data transfer channel for a data transfer; intercepting data packets of the data transfer channel if the data transfer is detected; reassembling intercepted data packets into reassembled data; detecting whether reassembled data include sensitive/confidential data corresponding to the security definitions; preventing detected data from transferring through the data transfer channel to the communication devices if the reassembled data comprise sensitive/confidential data; and formatting the reassembled data into the intercepted data packets and releasing the intercepted data packets, if the reassembled data do not comprise sensitive/confidential data. A related system is also disclosed.

### BACKGROUND OF THE INVENTION

1. Field of the Invention

The present invention generally relates to systems and methods for managing data, and more particularly to a system and method for managing a data transfer channel between communication devices.

2. Description of Related Art

With the continual technology advancement of computer servers and the Internet, transmitting/receiving relevant information via the Internet has become an important task for more and more people. Usually information carried by a data transfer channel is exchanged between communication devices such as a work computer, a client computer, a personal digital assistant (PDA), and the combination thereof. However, it is not secure if the information carried by the data transfer channel includes sensitive/confidential data and is exchanged between communication devices.

A relatively secure and simple method is to cut off data links between communication devices, so as to prevent confidential data from spreading by the Internet, and prevent an unauthorized operator from accessing the sensitive data. However, transmitting/receiving relevant information carried by data transfer channels via the Internet is needed to a person/an enterprise in a business. The secure and simple method usually shows that the loss outweighs the gain if a communication device is forbidden from connecting with another via the Internet.

What is needed, therefore, is a system and method that manages a data transfer channel between communication devices, that can prevent confidential data from spreading by the Internet, and prevent an authorized operator from accessing sensitive data via the Internet.

### SUMMARY OF THE INVENTION

A system for managing a data transfer channel between communication devices in accordance with a preferred embodiment includes a storage device and a data manager. The storage device is configured for storing security definitions. The data manager includes a monitoring module, an analyzing module, an intercepting module, a data processing module, and a data controlling module. The monitoring module is configured for monitoring the data transfer channel for a data transfer. The analyzing module is configured for waiting for the data transfer by communicating with the monitoring module, and for detecting whether reassembled data include sensitive/confidential data corresponding to the security definitions. The intercepting module is configured for intercepting data packets of the data transfer channel if the data transfer is detected. The data processing module is configured for reassembling intercepted data packets into the reassembled data, and for formatting the reassembled data into the intercepted data packets if the reassembled data do not comprise sensitive/confidential data. The data controlling module is configured for releasing the intercepted data packets if the reassembled data do not comprise sensitive/confidential data, and for preventing detected data from transferring through the data transfer channel to the communication devices if the reassembled data comprise sensitive/confidential data.

A method for managing a data transfer channel between communication devices in accordance with a preferred embodiment includes the steps of: monitoring the data transfer channel for a data transfer; intercepting data packets of the data transfer channel if the data transfer is detected; reassembling intercepted data packets into reassembled data; detecting whether reassembled data include sensitive/confidential data corresponding to the security definitions; preventing detected data from transferring through the data transfer channel to the communication devices if the reassembled data comprise sensitive/confidential data; and formatting the reassembled data into the intercepted data packets and releasing the intercepted data packets, if the reassembled data do not comprise sensitive/confidential data.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of a hardware configuration of a system for managing a data transfer channel between communication devices in accordance with a preferred embodiment;

FIG. 2 is a schematic diagram of main function sub-modules of a data manager of FIG. 1; and

FIG. 3 is a flowchart of a method for managing a data transfer channel between communication devices in accordance with a preferred embodiment.

### DETAILED DESCRIPTION OF THE INVENTION

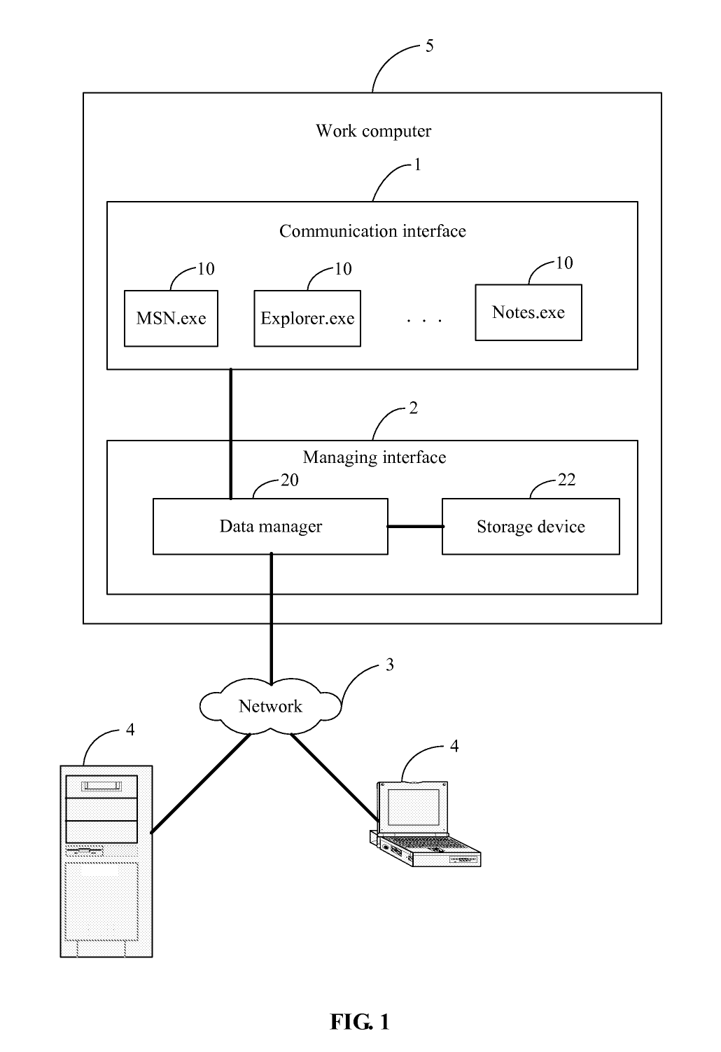

FIG. 1 is a schematic diagram of a hardware configuration of a system for managing a data transfer channel between communication devices (hereinafter, “the system”) in accordance with a preferred embodiment. The system typically includes a plurality of communication devices, such as a work computer 5, and a plurality of communication devices 4 (only two shown) connected to the work computer 5 via the Internet 3. The work computer 5 may include a communication interface 1, a managing interface 2 connected with the communication interface 1. A data transfer can be performed from one of above-mentioned communication devices such as the work computer 5, to another of above-mentioned communication devices such as the communication devices 4 through the data transfer channel. Both the work computer 5 and the communication devices 4 are configured (i.e., structured and arranged) for transmitting data carried by the data transfer channel, and the data transfer can be performed specifically between the communication interface 1 and the communication devices 4 through the data transfer channel. Both the work computer 5 and the communication devices 4 can be client computers, personal digital assistants (PDAs), or the like.

The communication interface 1 includes a plurality of data communicating tools 10 such as, Microsoft Network Messenger (shown with MSN.exe), Microsoft Internet Explorer (shown with explorer.exe), and Lotus Notes (shown with Notes.exe), for transmitting/receiving data carried by the data transfer channel between the data communicating tools 10 and the communication devices 4. The managing interface 2 includes a storage device 22 configured for storing security definitions predefined by a person, and a data manager 20 connected with the storage device 22, the communication interface 1 and the communication devices 4. The data manager 20 is configured for managing the data transfer channel between the communication interface 1 and the communication devices 4 by corresponding to the predefined security definitions. The security definitions are used for specifying sensitive/confidential data that is not permitted to be transferred between the communication interface 1 and the communication devices 4.

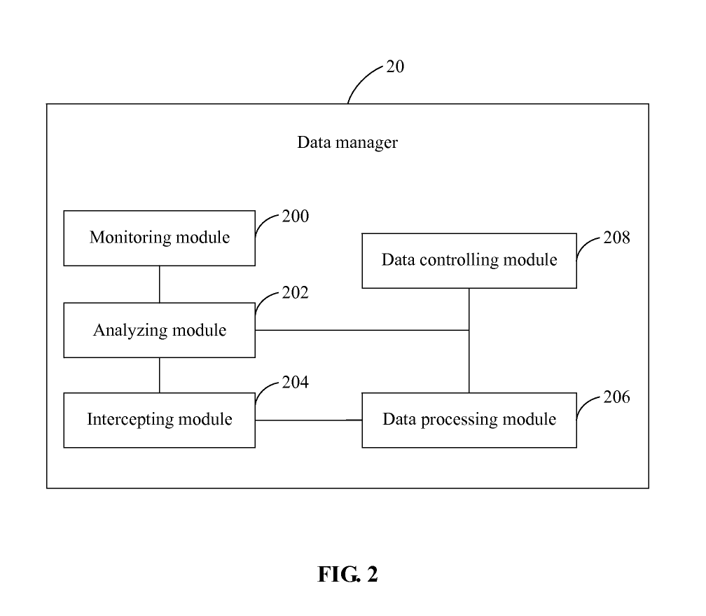

FIG. 2 is a schematic diagram of main function sub-modules of the data manager 20. The data manager 20 typically includes a monitoring module 200, an analyzing module 202, an intercepting module 204, a data processing module 206, and a data controlling module 208.

The monitoring module 200 is configured for monitoring the data transfer channel between the communication interface 1 and the communication devices 4 for a data transfer. It is generally known that a data transfer contained a destination address is performed when the work computer 5 is communicating with a communication device 4. The address of the data communicating tool 10 is the destination address if the data transfer is from the communication device 4 to the data communicating tool 10 through the data transfer channel. Otherwise, the address of the communication device 4 is the destination address if the data transfer is from the data communicating tool 10 to the communication device 4 through the data transfer channel.

The analyzing module 202 is configured for waiting for the data transfer by communicating with the monitoring module 200, and for detecting whether reassembled data include sensitive/confidential data corresponding to the predefined security definitions that specifies sensitive/confidential data not permitted to be transferred.

The intercepting module 204 is configured for intercepting data packets of the data transfer channel monitored by the monitoring module 200, and for retrieving the predefined security definitions from the storage device 22.

The data processing module 206 is configured for reassembling intercepted data packets into the reassembled data, and for formatting the reassembled data into the intercepted data packets if the reassembled data do not include sensitive/confidential data.

The data controlling module 208 is configured for releasing the intercepted data packets such that the monitored data transfer channel connection is allowed to transfer the intercepted data packets to the communication device 4 or the data communicating tool 10 according to destination address, if the reassembled data do not include sensitive/confidential data. The data controlling module 208 is further configured for preventing detected data from transferring through the monitored data transfer channel to the communication device 4 or the data communicating tool 10, if the reassembled data include sensitive/confidential data.

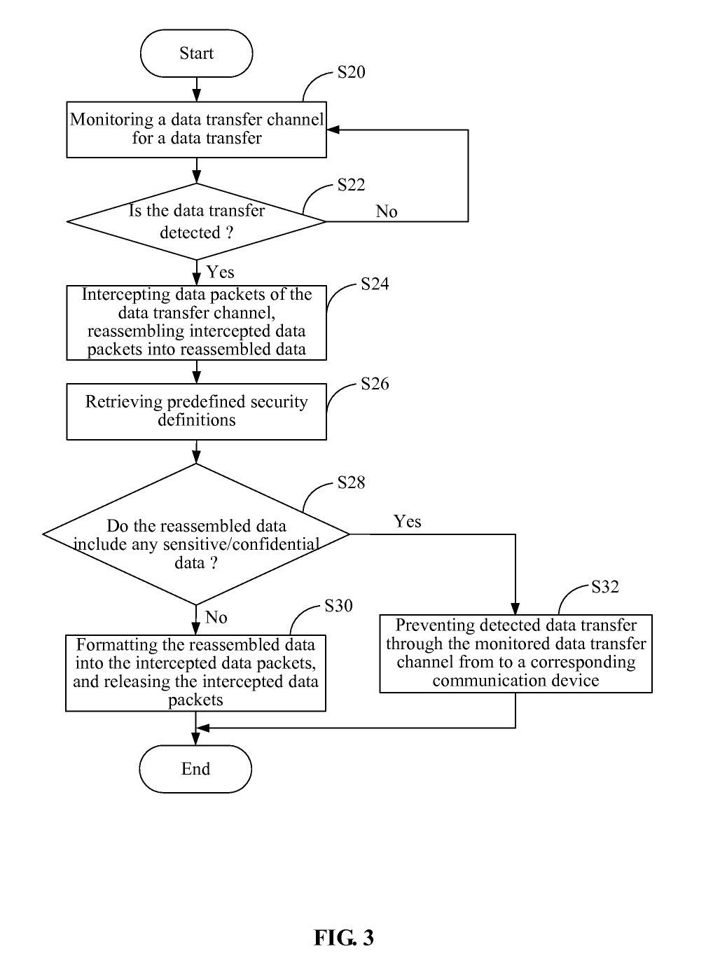

FIG. 3 is a flowchart of a method for managing a data transfer channel between communication devices by implementing the system as described above. In step S20, The monitoring module 200 monitors the data transfer channel between the communication interface 1 and the communication devices 4 for a data transfer.

In step S22, the analyzing module 202 waits for the data transfer by communicating with the monitoring module 200.

If the data transfer is not detected by the monitoring module 200, the procedure returns to step S20 as described above. Otherwise, if the data transfer is detected, in step S24, the intercepting module 204 intercepts data packets of the monitored data transfer channel, and the data processing module 206 reassembles data packets intercepted into reassembled data.

In step S26, the intercepting module 204 retrieves the security definitions from the storage device 22. In step S28, the analyzing module 202 detects whether the reassembled data include sensitive/confidential data corresponding to the predefined security definitions that specifies sensitive/confidential data not permitted to be transferred.

If the reassembled data do not include sensitive/confidential data, in step S30, the data processing module 206 formats the reassembled data into the intercepted data packets, and the data controlling module 208 releases the intercepted data packets such that the monitored data transfer channel connection is allowed to transfer the intercepted data packets to the communication device 4 or the data communicating tool 10 according to destination address.

Otherwise, if the reassembled data include sensitive/confidential data, in step S32, the data controlling module 208 prevents detected data from transferring through the monitored data transfer channel to the communication device 4 or the data communicating tool 10.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for managing a data transfer channel between communication devices, the system comprising:
a storage device configured for storing security definitions; and
a data manager comprising:
a monitoring module configured for monitoring the data transfer channel for a data transfer;
an analyzing module configured for waiting for the data transfer by communicating with the monitoring module, and for detecting whether reassembled data include sensitive/confidential data corresponding to the security definitions;
an intercepting module configured for intercepting data packets of the data transfer channel if the data transfer is detected;
a data processing module configured for reassembling intercepted data packets into the reassembled data, and for formatting the reassembled data into the intercepted data packets if the reassembled data do not comprise sensitive/confidential data; and
a data controlling module configured for releasing the intercepted data packets if the reassembled data do not comprise sensitive/confidential data, and for preventing detected data from transferring through the data transfer channel to the communication devices if the reassembled data comprise sensitive/confidential data.

2. The system as claimed in claim 1, wherein the security definitions are used for specifying sensitive/confidential data that is not permitted to be transferred between the communication devices.

3. The system as claimed in claim 1, wherein the communication devices are selected from the group consisting of computers and personal digital assistants (PDAs).

4. A method for managing a data transfer channel between communication devices, the method comprising the steps of:
monitoring the data transfer channel for a data transfer;
intercepting data packets of the data transfer channel if the data transfer is detected;
reassembling intercepted data packets into reassembled data;
detecting whether reassembled data include sensitive/confidential data corresponding to the security definitions;
preventing detected data from transferring through the data transfer channel to the communication devices if the reassembled data comprise sensitive/confidential data; and
formatting the reassembled data into the intercepted data packets and releasing the intercepted data packets, if the reassembled data do not comprise sensitive/confidential data.

5. The method as claimed in claim 4, wherein the predefined security definitions are used for specifying sensitive/confidential data that is not permitted to be transferred between the communication devices.

6. The method as claimed in claim 4, wherein the communication devices are selected from the group consisting of computers and personal digital assistants (PDAs).
